(19) United States
(12) Patent Application Publication
(10) Pub. No.: US 2008/0215731 A1
(43) Pub. Date: Sep. 4, 2008

(54) ATTRIBUTE GROUPING FOR ONLINE COURSE

(76) Inventors: Brandt Christian Redd, Provo, UT (US); James Russell Ivie, Lindon, UT (US); Mark Wolfgramm, Provo, UT (US); Brady S. Isom, Pleasant Grove, UT (US); Jeffery R. Gammon, Pleasant Grove, UT (US); Bernd Helzer, Draper, UT (US); Todd J. Hardman, Orem, UT (US); Paul Bryon Smith, Lehi, UT (US); Jiaxin Jerry Gao, Lehi, UT (US)

Correspondence Address: WORKMAN NYDEGGER, 60 EAST SOUTH TEMPLE, 1000 EAGLE GATE TOWER, SALT LAKE CITY, UT, 84111, US

(21) Appl. No.: 11/851,317

(22) Filed: Sep. 6, 2007

Related U.S. Application Data
(60) Provisional application No. 60/885,871, filed on Jan. 19, 2007.

(51) Int. Cl. G06F 15/173

(52) U.S. Cl. 709/225

(57) ABSTRACT

In an online computing system for providing a user with access to educational content in an online educational system, wherein the educational content includes access information. The method comprising organizing a hierarchy of user groups and domains, associating the user with a group or domain, receiving a request from a user to access educational content in the online educational system, retrieving information relating to the user's group or domain associations, retrieving the access information of the educational content that the user has requested to access, comparing the access information with the information relating to the user's group or domain associations, and determining whether the user has been authorized to access the requested educational content.

### CROSS-REFERENCE TO RELATED APPLICATIONS

This application claims priority to U.S. Provisional Application Ser. No. 60/885,871, filed on Jan. 19, 2007, and is incorporated herein by reference in its entirety.

### BACKGROUND OF THE INVENTION

1. The Field of the Invention

The present invention relates to accessing to online educational courses, and more particularly to a system and method of grouping various entities in a course authoring environment for controlling access to the online educational courses.

2. The Relevant Technology

Planning and creating course content often requires a large amount of time and expertise, particularly in situations where the coursework may be inspected by local, state or federal institutions to ensure that the curriculum meets educational standards. Because of the difficulties and expense required to develop successful course materials, many companies and professors have begun selling their course curriculums and course content to other educators interested in quickly and inexpensively developing a new course. Additionally, many large education companies have opted to share the expense of developing course materials by partnering with other companies and sharing coursework. In a recently developed system, the purchase or reciprocity agreement may include the ability to modify, customize, or selectively use the elements of a course to create a new course.

Advantageously, this allows a teacher or course administrator to develop a course curriculum that meets the needs of his or her course. Additionally, the ability to share materials between teachers and course developers helps to create an efficient and sophisticated group authoring system where a group of authors, each with expertise in the subject can work together to create a series of course materials. Ideally, this shared environment will result in a series of collaborative course materials that will more effectively teach the subject matter to students by utilizing the shared experience and expertise of the teachers and course developers.

One difficulty in creating the shared authoring and administrative environment is monitoring and controlling access to the course content. In order to effectively monitor and control the collaborative course authoring environment, the system needs to be able to grant access to a group of teachers, while being secure enough to ensure the integrity of the system and the course materials. Thus, there is a need for a method and system for efficiently grouping entities in order to monitor and control the access to the educational content in an online collaborative course environment.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF THE INVENTION

These and other limitations are overcome by embodiments of the invention which relate to systems and methods for providing or denying a user access to educational content in an online computing system.

This summary is provided to introduce a selection of concepts in a simplified form that are further described below in the Detailed Description. The summary is not intended to identify key features or essential characteristics of the claimed subject matter, nor is it intended to be used as an aid in determining the scope of the claimed subject matter.

One aspect of the invention is the ability to create a hierarchy of users, organized into groups and domains of users, which may be used to organize users according to their roles in the education system. Using this hierarchy, a system administrator can easily and efficiently control access to the educational content by assigning access rights to users individually or to groups or domains.

The invention further includes a method for providing a user with access to educational content in an online educational system, wherein the educational content includes access information including organizing a hierarchy of user groups and domains, associating the user with a group or domain. Upon receiving a request from the user to access educational content in the online educational system, the system retrieves information relating to the user's group or domain associations, along with the access information of the requested educational content. Using this information, the system compares the access information with the information relating to the user's group or domain associations, and determines whether the user has been authorized to access the requested educational content.

Another aspect of the invention is a method for providing a user with access to educational content in an online educational system, wherein the educational content includes access information comprising a listing of users, groups, and domains which have been authorized to access the educational content, the method comprising organizing a hierarchy of user groups and domains, associating the user with a group or domain, receiving a request from a user to access educational content in the online educational system, retrieving information relating to the user's group or domain associations, retrieving the access information of the educational content that the user has requested to access, comparing the access information with the information relating to the user's group or domain associations, and granting the user access to the requested educational content if the access information authorizes the user or a group or domain associated with the user to access the educational content.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a block diagram illustrating an exemplary system capable of performing the invention;

FIG. 2 is a diagram illustrating a hierarchy of users of the system in accordance with the invention;

FIG. 3 is a diagram illustrating the access information of educational content of the system; and

FIG. 4 is a block diagram illustrating a method of providing a user with access to educational content in an online educational system.

### DETAILED DESCRIPTION OF THE PREFERRED EMBODIMENTS

Various embodiments of the invention relate to systems and method for providing a user with access to online courses through attribute grouping.

As used herein, the term “user” may be used to describe students, employees, content authors, educators, employers, course administrators, or system administrators who are accessing the education management system using a computer. The computer may be any specific of general computer system that is equipped to receive, send, and process educational content. The computer may be, for example, a personal computer, portable computer, handheld device, or any other computing machine. A suitable computer system may include a modem, a monitor, a keyboard, a mouse, system software including support for TCP/IP communication, and other various types of software. Further, more than one user may connect to the education management system using the same computer.

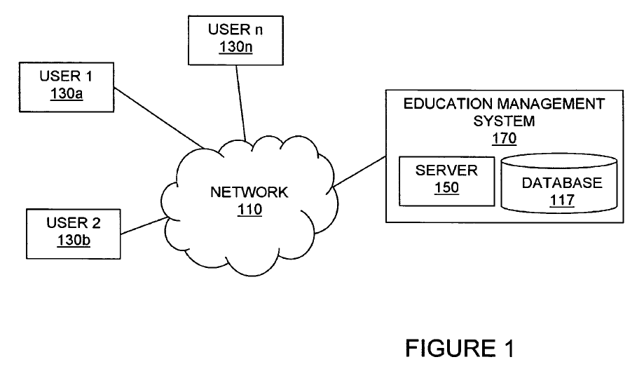

FIG. 1A is a block diagram illustrating an exemplary system capable of performing the present invention. As shown, the system includes a number of users, “User 1” 130a through “User n” 130n, who are connected to an educational management system 170 via a network connection 120. As will be understood by one of ordinary skill in the art, the network 120 may be any local or global network, including a LAN, WAN, wireless network, internet connection, and the like.

In one embodiment of the invention, the education management system 170 includes a server 150 capable of sending and receiving communications and data via the network 120, along with a database 117 capable of storing a plurality of educational software and data. In addition, the database 117 can be used to store data relating to the user identification. As will be understood by one of ordinary skill in the art, any number of configurations may be used to create an education system, including systems using a series of interconnected databases, computers, and servers.

One aspect of the invention is the ability to use a single networked system to store educational content that may be developed and shared between the various users of the system. Using the access control system described more fully below, the system is able to effectively and efficiently manage each user's ability to access information stored in the system. In addition, the invention provides a scalable solution, meaning that the system can effectively control and monitor the users' ability to access the educational content for a large number of users.

As described more fully below, another aspect of the invention is the ability to organize users of the system into a hierarchical structure according to each user's respective role in the system. Users may be grouped together. For example, users with similar roles who are likely to require access to the same files can be joined into the same user group. Using these groups, a system administrator can grant and deny access to an entire group of users without having to individually assign access rights to each user.

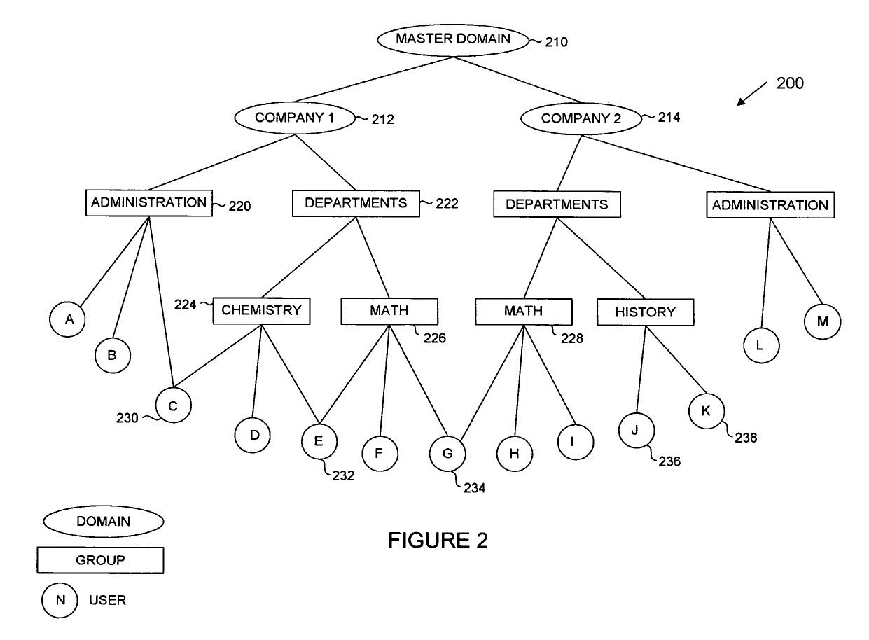

FIG. 2 illustrates an exemplary hierarchy of users. The hierarchy is comprised of domains, groups, and users, wherein a domain may contain other domains, groups, or users and a group may contain other groups and users. In this example, the users “A” to “N” are organized in one master domain 210 according to their respective roles in two companies, “Company 1” 212 and “Company 2” 214. Here, users who are customers or employees of “Company 1” are further organized into groups of users according to their roles within “Company 1” and “Company 2.” For example, here, the “Company 1” domain 212 includes two groups, “Administration” 220 and “Departments” 222, and the “Company 2” domain 214 is similarly divided.

Another aspect of the invention is the ability to associate a user with one or more group or domain. Advantageously, this allows the course administrator to create a organizational structure that closely mirrors each user's role with the system. For example, user “C” 230 may be a department chair of the Company 1's Chemistry department. In order to fulfill his responsibilities, he likely would require access to administrative content as well as the chemistry course materials used in his department. Thus, user “C” 230 can be assigned to the “Administration” group 220, the “Departments” group 222, and the “Chemistry” group 224. In another example, user “E” 232 may be a faculty member who teaches both chemistry and mathematics classes for Company 1. In his roles in each department, user “E” 232 will require access to both content that will be used in both math and chemistry courses. Thus, he may be associated with both the “Chemistry” group 224 and the “Math” group 226.

In addition, a user may be associated to with more than one domain. For example, user “G” may be a consultant for both Company 1 and Company 2 who assists with course development for mathematics courses. Thus, he may be associated with the “Math” group 226 in the “Company 1” domain 212 in addition to the “Math” group 228 in the “Company 2” domain 214. Thus, one aspect of the invention is a flexible hierarchical structure that allows a course administrator to associate the users into groups according to their roles in the system.

Advantageously, the ability to create groups and domains that mirror the corporate structure of the users of the system gives a course administrator sufficient granularity to grant and deny access to the educational content to an entire group or domain, rather than requiring the administrator to individually monitor the access settings of each user. Thus, when a new user is hired as an employee, by associating the employee with the user group(s) and domains corresponding to the user's new position, the course administrator can inherit the access controls of the user's associated groups.

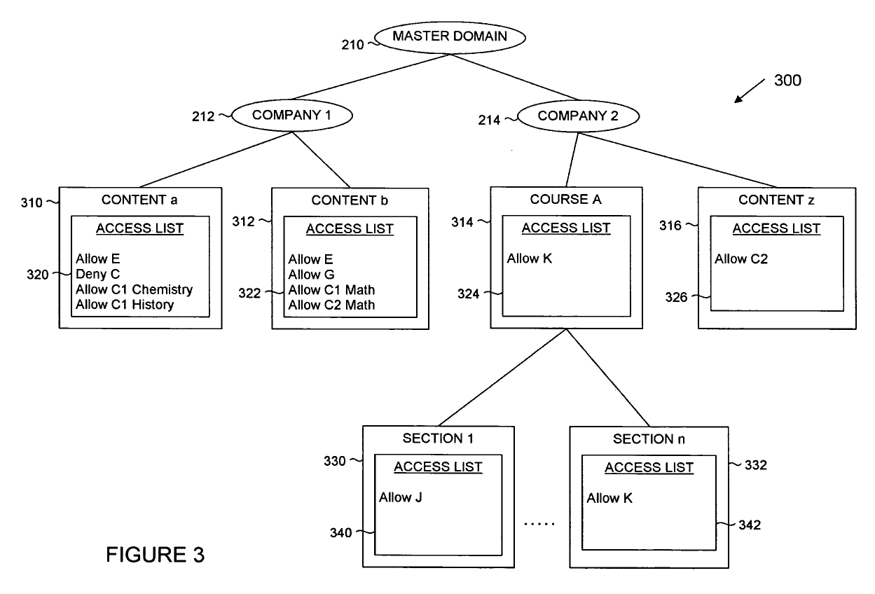

FIG. 3 illustrates a system of organizing the educational content in the system that may be used in association with the present invention. In this example, the content is organized in a master domain 21. Here, it is assumed that the educational content is stored within a central database 117 which resides in the education management system 170. Within the system 170, the content may be divided or stored in any number of configurations, partitions, or other organized data systems. Such configurations may relate to the physical location of the data or may be implemented for the storage, hierarchical organization, manipulation, navigation, access, or retrieval of the data.

In the example shown in FIG. 3, the content is stored within a master domain 210 divided into the domains “Company 1” 212 and “Company 2” 214. These domains contain the various educational content of the respective companies. As shown in FIG. 2, the content may be stored directly within the domains, such as “Content a” 310, “Content b” 312, and “Content z” 316, or the content may be further organized, such as the “Section 1” 330 and “Section n” 332 being organized by their master course “Course A” 314.

Together with FIG. 2, FIG. 3 illustrates another aspect of the invention is the ability to use an access list or other access information associated with each educational content within the system. These access lists may be used to designate a user, group, or domain for access or denial to the content. In this example, “Content a” 310 has an access list 320 indicating that the system should allow “user E” 232, deny “user C” 230, allow the “Company 1 Chemistry Department” 224, and allow the “Company 1 Math Department” 226. Thus, by using an access list that gives both the “Chemistry Department” 224 and the “Math Department” 226 access to the educational content, the system can allow the two departments to share the content without requiring each department to store and maintain its own copy of the educational content.

“Content b” 312 is an example of educational content that may be shared between one or more domains, or in this instance, one or more educational companies of the system has an access list 322 indicating that the system should allow “user E” 232, “user G” 234, allow the “Company 1 Math Department” 226, and the “Company 1 Math Department” 228. Thus, one advantage of the invention is a secure and efficient method of sharing content between one or more educational entities, allowing the entities to save time and money spent in developing and updating course materials.

In some situations, an entity may wish to give an entire group or domain of users access to content, such as “Content z” 316, which has an access list indicating that the entire “Company 2” 214 domain is permitted access to the “Content z” 316. In other instances, the entity may wish to create a hierarchy of content, with different access controls at each level of the hierarchy. For example, FIG. 3 illustrates “Course A” 314 sub-category of educational content divided into individual or customized versions of the course, which are designated “Section 1” 330 and “Section n” 332. Here, it is assumed that “user K” 238 is the author of the course content, thus the “Course A” 314 access list 324 indicates that only “user K” 238 is permitted to access the content. Often, however, a course may be administered or taught by a teacher who is not the author of the content. In such situations, it is necessary to alter the access settings of the content such that the administrator or teacher is given access to the particular section he or she is teaching. In this example, “Course A” 314 is further associated with sections of “Course A” 314 which are designated “Section 1” 330 (taught by “user J” 236) and “Section n” 332 (taught by “user K” 238).

Another aspect of the invention is the ability to create access rights that may be inherited through the organization of the content using the course and section designations. Thus, in one embodiment, “Section 1” 330 may inherit the access rights of “Course A” 314, meaning that because “user K” 238 is granted access in the access list 324 of “Course A” 314, and “Section 1” 330 is associated with “Course A” 314, “user K” 238 may be granted access to “Section 1” 330. In other embodiments, the access rights may not be inheritable through section and course associations.

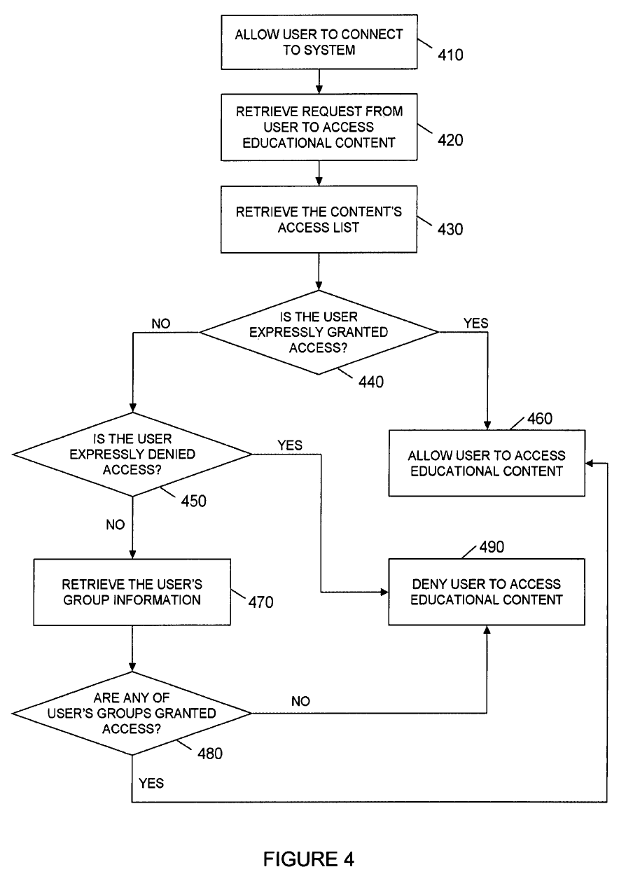

Together with FIGS. 2 and 3, FIG. 4 illustrates a method of providing a user with access to educational content in an online educational system. First, the user connects 410 to the system, using an authentication process. Next, the user requests 420 access to the educational content. At 430, the system retrieves the access information of the requested content. As previously described, the access information includes a listing of users, groups, and domains who have been allowed or denied access to the content. Using this access information, at 440 the system determines whether the user individually has been expressly granted access in the access information. If at 440 it is determined that the user has been granted access to the content, then the user is allowed access to the content and the process ends.

If at 440 it is determined that the user has not been expressly granted access, the system continues to 450 where the system determines if the user has been expressly denied access to the requested content. If at 450 it is determined that the user has been expressly denied access to the content, then the system denies the user access to the content and the process ends. If at 450 it is determined that the user has not been expressly denied access to the content, then the system retrieves 470 the user's group and domain associations. In one embodiment, this may be performed by discovering the group and domain associations of the system hierarchy shown in FIG. 2.

Once all of the user's group and domain associations have been retrieved, then at 480 the system determines if any of the user's associated groups or domains have been granted access to the requested content. If at 480 it is determined that one of the user's groups or domains has been granted access, then the user is given access to the requested content and the process ends. Conversely, if at 480 it is determined that none of the user's groups or domains have been granted access to the requested content, then the user is denied access to the requested content and the process ends.

Thus a user may be granted access to the educational content expressly, by being individually authorized to access the content, or the access may be inherited via the user's association with an authorized group or domain. Furthermore, using the method described above, a user may be denied access to specific content if he or she has been expressly designated to be denied access in the object's access information, despite the user's association with a group which has been granted access to the specific object, because the system first determines if the user has been individually designated before it grants or denies access based on the user's group or domain associations.

In one implementation, rights may only be granted from users or groups to domains, courses and sections. In other words, only users and groups may have rights, and those rights may be limited to grant access to domains, courses and sections. In this implementation, users inherit the rights of their groups, and rights granted to domains are also granted to courses and sections within those domains.

Thus, one aspect of the invention is a system of inheritable access rights, wherein the express allowance or denial of a user's ability to access educational content is given priority over subsequent group or domain associations. Advantageously, this allows a system administrator to efficiently grant access to large numbers of users in a single group, while retaining the ability to adjust or modify those rights on an individual basis, if needed. Thus, the present invention provides an effective and efficient method of providing a large number of users with various roles and responsibilities with access to the educational content that the require, while keeping other content secure.

The embodiments described herein may include the use of a special purpose or general-purpose computer including various computer hardware or software modules, as discussed in greater detail below.

Embodiments within the scope of the present invention also include computer-readable media, recordable-type media, or physical storage media for carrying or having computer-executable instructions or data structures stored thereon. Such computer-readable media, recordable-type media, or physical storage media can be any available media that can be accessed by a general purpose or special purpose computer. By way of example, and not limitation, such computer-readable media, recordable-type media, or physical storage media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable, recordable-type media, or physical storage medium. Thus, any such connection is properly termed a computer-readable medium. Combinations of the above should also be included within the scope of computer-readable media, recordable-type media, or physical storage media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In an online computing system of users, a method for providing a user with access to educational content in an online educational system, wherein the educational content includes access information, the method comprising:
organizing a hierarchy of user groups and domains;
associating the user with a group or domain;
receiving a request from a user to access educational content in the online educational system;
retrieving information relating to the user's group or domain associations;
retrieving the access information of the educational content that the user has requested to access;
comparing the access information with the information relating to the user's group or domain associations; and
determining whether the user has been authorized to access the requested educational content.

2. The method of claim 1, wherein the access information comprises a listing of users, groups, and domains which have been authorized to access the educational content.

3. The method of claim 1, wherein the access information comprises a listing of users, groups, and domains which are not authorized to access the educational content.

4. The method of claim 2, wherein determining whether the user has been authorized to access the requested educational content comprises granting access to the user if the access information authorizes the user or a group or domain associated with the user to access the educational content.

5. The method of claim 1, wherein the educational content is selected from a list comprising at least one of courses, sections, assignments, quizzes, tests, projects, presentations, worksheets, games, puzzles, lectures, and outlines.

6. The method of claim 1, wherein the user is selected from a list comprising a student, teacher, course administrator, system administrator, or content author.

7. The method of claim 1, wherein a user may be associated with more than one group or domain.

8. The method of claim 1, wherein associating the user with a group or domain comprises associating a user with a group or domain according to the user's role in the online computing system, wherein users of similar roles are associated in the same group or domain.

9. The method of claim 1, wherein a domain is comprised of users, domains, and/or groups.

10. The method of claim 1, wherein a group is comprised of users and/or groups.

11. The method of claim 1, wherein a group may be associated with more than one group or domain.

12. In an online computing system, a method for providing a user with access to educational content in an online educational system, wherein the educational content includes access information comprising a listing of users, groups, and domains which have been authorized to access the educational content, the method comprising:
organizing a hierarchy of user groups and domains;
associating the user with a group or domain;
receiving a request from a user to access educational content in the online educational system;
retrieving information relating to the user's group or domain associations;
retrieving the access information of the educational content that the user has requested to access;
comparing the access information with the information relating to the user's group or domain associations; and
granting the user access to the requested educational content if the access information authorizes the user or a group or domain associated with the user to access the educational content.

13. The method of claim 12, wherein the educational content is selected from a list comprising at least one of courses, sections, assignments, quizzes, tests, projects, presentations, worksheets, games, puzzles, lectures, and outlines.

14. The method of claim 12, wherein the user is selected from a list comprising a student, teacher, course administrator, system administrator, or content author.

15. The method of claim 12, wherein a user may be associated with more than one group or domain.

16. The method of claim 12, wherein associating the user with a group or domain comprises associating a user with a group or domain according to the user's role in the online computing system, wherein users of similar roles are associated in the same group or domain.

17. The method of claim 12, wherein a domain is comprised of users, domains, and/or groups.

18. The method of claim 12, wherein a group is comprised of users and/or groups.

19. The method of claim 12, wherein a group may be associated with more than one group or domain.

20. An educational management system for providing a user with access to educational content in an online educational system, the system comprising:
a server capable sending and receiving requests from the user, organizing the user within a hierarchy of user groups and domains and determining whether the user has been authorized to access the requested educational content; and
a database capable of storing a plurality of educational content;
wherein the educational content includes access information comprising a listing of users, groups, and domains which have been authorized to access the educational content, and determining whether the user has been authorized to access the requested educational content comprises comparing the access information with the information relating to the user's group or domain associations.
